(19) United States
(12) Patent Application Publication
(10) Pub. No.: US 2026/0038088 A1
(43) Pub. Date: Feb. 5, 2026

(54) DEVICE AND METHOD FOR IMAGE PROCESSING

(71) Applicant: SK hynix Inc., Icheon-si (KR)

(72) Inventor: Takuya KOTANI, Tokyo (JP)

(21) Appl. No.: 19/286,179

(22) Filed: Jul. 30, 2025

(30) Foreign Application Priority Data
Jul. 31, 2024 (KR) 10-2024-0102053

(51) Int. Cl. G06T 5/50; G06T 7/90

(52) U.S. Cl. CPC G06T 5/50; G06T 7/90; G06T 2207/10024; G06T 2207/10144; G06T 2207/20221

(57) ABSTRACT

An image processing device is provided to comprise: a luminance correction circuit configured to receive a first image and a second image of a target scene or object and generate a third image by selectively replacing the second image with the first image based on a relationship between pixel values at a same position in the first image and the second image; and an image composition circuit communicatively coupled to the luminance correction circuit to receive the first image and the third image and configured to generate a fourth image by composing the first image and the third image based on a color-specific brightness value of the first image or the third image and threshold values associated with each color.

### PRIORITY CLAIM AND CROSS-REFERENCE TO RELATED APPLICATION

This patent document claims the benefit of priority to Korean Patent Application No. 10-2024-0102053, filed in the Korean Intellectual Property Office on Jul. 31, 2024, the entire contents of which are incorporated herein by reference.

### TECHNICAL FIELD

The disclosure of this patent document relates to a device and a method for processing an image.

### BACKGROUND

An image sensing device is a device for capturing an optical image by using the property of a photosensitive semiconductor material which reacts to a light. With the development of automotive, medical, computer and communication industries, the demand for a high-performance image sensing device is increasing in various fields such as a smartphone, a digital camera, a game machine, an IoT (Internet of Things), a robot, a security camera, and a medical micro camera.

### SUMMARY

An aspect of the present disclosure provides an image processing device which composes images with different brightnesses.

An aspect of the present disclosure provides an image processing device which composes images by using different threshold values associated with each color and a color-specific brightness value.

An aspect of the present disclosure provides an image processing device which correct luminance by selectively replacing an image with any other image.

An aspect of the present disclosure provides an image processing device which composes images by using a pixel value of any other image when a pixel value of an image is in a saturation state.

The technical problems to be solved by the present disclosure are not limited to the aforementioned problems, and any other technical problems not mentioned herein will be clearly understood from the following description by those skilled in the art to which the present disclosure pertains.

In one aspect, an image processing device may include a luminance correction circuit configured to receive a first image and a second image of a target scene or object and generate a third image by selectively replacing the second image with the first image based on a relationship between pixel values at a same position in the first image and the second image; and an image composition circuit communicatively coupled to the luminance correction circuit to receive the first image and the third image and configured to generate a fourth image by composing the first image and the third image based on a color-specific brightness value of the first image or the third image and threshold values associated with each color.

According to an embodiment, the image processing device may further include a gain control circuit communicatively coupled to the luminance correction circuit and configured to generate the first image by correcting a first input image based on a first gain, and generate the second image by correcting a second input image based on a second gain greater than the first gain, and the first input image is captured during an exposure time longer than an exposure time of the second input image.

According to an embodiment, the image composition circuit may be configured to generate the fourth image by using a pixel value of a first green pixel of the first image, in response to a brightness value of the first green pixel being smaller than a first green threshold value, generate the fourth image by adding the pixel value of the first green pixel and a pixel value of a second green pixel of the third image at a given ratio, in response to the brightness value of the first green pixel is greater than or equal to the first green threshold value and is smaller than a second green threshold value, and generate the fourth image by using the pixel value of the second green pixel, in response to the brightness value of the first green pixel being greater than or equal to the second green threshold value.

According to an embodiment, the image composition circuit may be configured to generate the fourth image by using a pixel value of a first red pixel of the first image, in response to a brightness value of the first red pixel of the first image being smaller than a first red threshold value, generate the fourth image by adding the pixel value of the first red pixel and a pixel value of a second red pixel of the third image at a given ratio, in response to the brightness value of the first red pixel being greater than or equal to the first red threshold value and is smaller than a second red threshold value, and generate the fourth image by using the pixel value of the second red pixel, in response to the brightness value of the first red pixel being greater than or equal to the second red threshold value.

According to an embodiment, the image composition circuit may be configured to generate the fourth image by using a pixel value of a first blue pixel of the first image, in response to a brightness value of the first blue pixel being smaller than a first blue threshold value, generate the fourth image by adding the pixel value of the first blue pixel and a pixel value of a second blue pixel of the third image at a given ratio, in response to the brightness value of the first blue pixel being greater than or equal to the first blue threshold value and is smaller than a second blue threshold value, and generate the fourth image by using the pixel value of the second blue pixel, in response to the brightness value of the first blue pixel being greater than or equal to the second blue threshold value.

According to an embodiment, the given ratio may linearly change as the brightness value of the first green pixel increases from the first green threshold value to the second green threshold value.

According to an embodiment, the first green pixel may be in a saturation state in response to the brightness value of the first green pixel being identical to the second green threshold value.

According to an embodiment, the brightness value of the first green pixel may correspond to the pixel value of the first green pixel.

According to an embodiment, the first green threshold value and the second green threshold value may be determined by at least some of a spectral sensitivity characteristic of a color filter of an image sensing device coupled to the image processing device and a white balance value.

According to an embodiment, the luminance correction circuit may be configured to generate the third image by replacing a second pixel value of the second image with a first pixel value of the first image, in response to the first pixel value being greater than or equal to the second pixel value.

In another aspect, an image processing device may include an image composition circuit configured to receive a first image and a second image of a target scene or object. The image composition circuit is configured to: perform a first composition of a pixel value of a first green pixel of the first image and a pixel value of a second green pixel of the second image based on depending on a relationship between any two of a brightness value of the first green pixel of the first image, a first green threshold value, and a second green threshold value; perform a second composition of a pixel value of a first blue pixel of the first image and a pixel value of a second blue pixel of the second image depending on a relationship between a brightness value of the first blue pixel of the first image, a first blue threshold value, and a second blue threshold value; and perform a third composition of a pixel value of a first red pixel of the first image and a pixel value of a second red pixel of the second image depending on a relationship between a brightness value of the first red pixel of the first image, a first red threshold value, and a second red threshold value, wherein the image composition circuit is further configured to generate a third image based on the first composition, the second composition and the third composition.

According to an embodiment, the image processing device may further include a gain control circuit configured to generate the first image by correcting a first input image by using a first gain, and generate a fourth image by correcting a second input image by using a second gain greater than the first gain, and the first input image may be captured during an exposure time longer than an exposure time of the second input image.

According to an embodiment, the image processing device may further include a luminance correction circuit communicatively coupled to the image composition circuit and configured to generate the second image by selectively replacing the fourth image with the first image depending on a large-small relationship between pixel values at a same position in the first image and the fourth image.

According to an embodiment, the image composition circuit may be configured to generate the third image by using the pixel value of the first green pixel, in response to a brightness value of the second green pixel being smaller than the first green threshold value, generate the third image by adding the pixel value of the first green pixel and the pixel value of the second green pixel at a given ratio, in response to the brightness value of the second green pixel being greater than or equal to the first green threshold value and being smaller than the second green threshold value, and generate the third image by using the pixel value of the second green pixel, in response to the brightness value of the second green pixel being greater than or equal to the second green threshold value.

According to an embodiment, the image composition circuit may be configured to generate the third image by using the pixel value of the first blue pixel, in response to a brightness value of the second blue pixel being smaller than the first blue threshold value, generate the third image by adding the pixel value of the first blue pixel and the pixel value of the second blue pixel at a given ratio, in response to the brightness value of the second blue pixel being greater than or equal to the first blue threshold value and smaller than the second blue threshold value, and generate the third image by using the pixel value of the second blue pixel, in response to the brightness value of the second blue pixel being greater than or equal to the second blue threshold value.

According to an embodiment, the image composition circuit may be configured to generate the third image by using the pixel value of the first red pixel, in response to a brightness value of the second red pixel being smaller than the first red threshold value, generate the third image by adding the pixel value of the first red pixel and the pixel value of the second red pixel at a given ratio, in response to the brightness value of the second red pixel being greater than or equal to the first red threshold value and smaller than the second red threshold value, and generate the third image by using the pixel value of the second red pixel, in response to the brightness value of the second red pixel being greater than or equal to the second red threshold value.

In some implementations, the first green pixel is in a saturation state when the brightness value of the first green pixel is identical to the second green threshold value.

According to an embodiment, the first green threshold value and the second green threshold value may be determined by at least some of a spectral sensitivity characteristic of a color filter and a white balance value.

According to an embodiment, the brightness value of the first green pixel may correspond to the pixel value of the first green pixel.

In another aspect, an image processing method may include obtaining a first image and a second image of a target scene or object; generating a third image by replacing a second pixel value of the second image with a first pixel value of the first image, in response to the first pixel value being greater than or equal to the second pixel value, and generating a fourth image by composing the first image and the third image by using a color-specific brightness value of the first image or the third image and threshold values associated with each color.

The features briefly summarized above with respect to the present disclosure are merely example aspects of the detailed description of the present disclosure to be described below, and do not limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of an image processing device to according to an example embodiment of the present disclosure;

FIG. 2 is a diagram of an image processing method according to an example embodiment of the present disclosure;

FIG. 3A is a diagram for describing an image processing method according to an embodiment of the present disclosure;

FIG. 3B is a diagram for describing an image processing method according to an example embodiment of the present disclosure;

FIG. 4 is a flowchart of an image processing method according to an example embodiment of the present disclosure;

FIG. 5 is a flowchart of an image processing method according to an example embodiment of the present disclosure;

FIG. 6A is a diagram for describing an image processing method according to a comparative example;

FIG. 6B is a diagram for describing an image processing method according to a comparative example;

FIG. 6C is a diagram for describing an image processing method according to an example embodiment of the present disclosure; and

FIG. 7 is a block diagram illustrating an example of a computing device corresponding to an image processing device of FIG. 1.

### DETAILED DESCRIPTION

Hereinafter, an embodiment of the present disclosure will be described with reference to the accompanying drawings to such an extent as to be easily embodied by one skilled in the art. However, the present disclosure may be implemented in several different forms and is not limited to the embodiments described herein.

In describing an embodiment of the present disclosure, when it is determined that a detailed description of a well-known configuration or function may obscure the gist of the present disclosure, the detailed description thereof will be omitted. Parts not related to the description of the present disclosure are omitted in the drawings, and similar parts are denoted by similar reference numerals/signs throughout the specification.

The images captured by the image sensing device may be different depending on an exposure time, a gain, etc., and the distortion of image may be caused due to a flicker phenomenon. Some implementations of the disclosed technology can be provided to provide an image processing device and method which can address such issues.

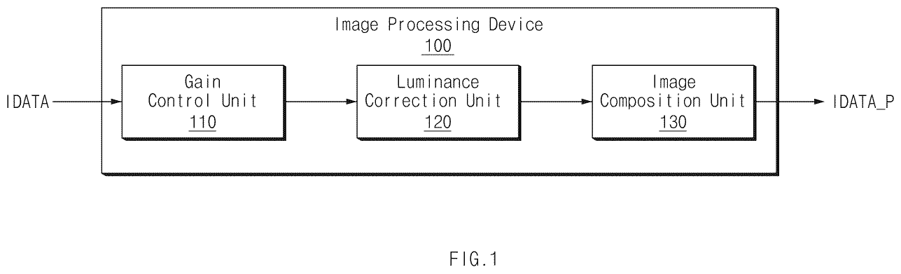

Below, example embodiments of the present disclosure will be described in detail with reference to FIGS. 1 to 7.

FIG. 1 is a block diagram of an image processing device according to an example embodiment of the present disclosure.

Referring to FIG. 1, an image processing device 100 may generate processed image data IDATA_P by performing at least one image signal processing on image data IDATA from an image sensing device.

The image processing device 100 may reduce the noise of the image data IDATA and may perform image signal processing for improving the quality of image, such as demosaicing, defect pixel correction, gamma correction, color filter array interpolation, color matrix, color correction, color enhancement, or lens distortion correction. In some implementations, the image processing device 100 may generate an image file by performing compression processing on image data experiencing the image signal processing for improving the quality of image or may recover the image data from the image file. A compression format of an image may be a reversible format or an irreversible format. As an example of the compression format, the JPEG (Joint Photographic Experts Group) format or the JPEG 2000 format may be used for a still image. Also, in the case of a moving image, a moving image file may be generated by compressing a plurality of frames in compliance with the MPEG (Moving Picture Experts Group) standard.

The image data IDATA may be generated by an image sensing device which captures an optical image of a target scene or object. But the scope of the present disclosure is not limited to the above scenario: the image data IDATA may be from other sources, e.g., image data stored in a storage device. The image sensing device may include a pixel array which includes a plurality of pixels for sensing a light incident from the scene, a control circuit for controlling the pixel array, and a readout circuit which converts and outputs a pixel signal of an analog form received from the pixel array into the image data IDATA of a digital form. In the present disclosure, the description will be given on the assumption that the image data IDATA is generated by the image sensing device.

The pixel array may include a color filter array (CFA) in which color filters are arranged based on a given pattern (e.g., a Bayer pattern, a quad Bayer pattern, a Nona Bayer pattern, or an RGBW pattern) such that a light in a preset waveform band is capable of being sensed. A pattern which the image data IDATA have may be defined depending on a kind of a pattern which the CFA has.

The image processing device 100 may be a computing device which is mounted on a chip independent of a chip on which the image sensing device is mounted, but the present disclosure is not limited thereto. The chip on which the image sensing device is mounted and the chip on which the image processing device 100 is mounted may communicate with each other through a given interface. According to an embodiment, the chip on which the image sensing device is mounted and the chip on which the image processing device 100 is mounted may be implemented with a single package, for example, a multi-chip package (MCP), but the scope of the present disclosure is not limited thereto.

The image processing device 100 may include a gain control unit 110, a luminance correction unit 120, and/or an image composition unit 130. The gain control unit 110, the luminance correction unit 120, and/or the image composition unit 130 are elements of the image processing device 100 that perform the certain functions and are implemented as logical and electrical circuits/components to perform the certain functions.

The gain control unit 110 may control a gain to be applied to an input image. For example, the gain control unit 110 may determine the gain based on an exposure time applied when the input image is captured and may apply the gain to the input image. Assume that the image processing device 100 receives a first input image and a second input image of a target scene or object that is captured and generated by an image sensing device. For example, the gain control unit 110 may generate a first image by correcting the first input image by using a first gain to amplify the first input image. Also, the gain control unit 110 may correct the second input image by using a second gain greater than the first gain to amplify the second input image and this process generates a second image. In this case, the first input image may be an image captured from the target scene or object by using an exposure time longer than that for capturing the second input image. Thus, the first input image may be an image which is brighter than the second input image under the same or a similar illumination condition in capturing the images. When a signal of a saturation region is included in the first input image due to a long exposure time, a signal of a brighter region than the saturation region may be obtained by applying the second gain to the second input image which is darker than the first input image. How to apply a gain will be described in detail later.

The luminance correction unit 120 may correct the luminance of an image. In some implementations, the luminance correction unit 120 may correct the luminance of the image by replacing a pixel value of a single image with a pixel value of another image. For example, when the gain control unit 110 generates the first image and the second image, the luminance correction unit 120 may generate a third image by selectively replacing the second image with the first image based on the large-small relationship between pixel values of pixels of the first image and the second image, the pixels being placed at the same location of the first image and the second image, respectively. The pixel values of the first pixel of the first image and the second pixel of the second image, which are placed at the same location of the first image and the second image, are respectively referred to as a “first pixel value” and a “second pixel value”. The large-small relationship defines the magnitude relationship between the first pixel value and the second pixel value, e.g., which of two pixel values is greater. In some implementations, the large-small relationship between the first pixel value and the second pixel value refers to the relative comparison based on the luminance or brightness represented by each pixel value. For example, when the first pixel value is greater than the second pixel value, it indicates that the first image is relatively brighter than the second image. When the large-small relationship satisfies that the first pixel value of the first pixel of the first image is greater than or equal to the second pixel value of the second pixel of the second image, the luminance correction unit 120 may generate the third image by replacing the second pixel value of the second pixel of the second image with the first pixel value of the first pixel of the first image, the first pixel and the second pixel having the same location in the first image and the second image, respectively. The luminance correction unit 120 will be described in detail later.

The image composition unit 130 may compose images input thereto. In some implementations, the image composition unit 130 may compose the input images based on brightness values of the input images. For example, the image composition unit 130 may generate a fourth image by composing the first image and the third image by using a color-specific brightness value of the first image or the third image and different threshold values associated with each color. The image composition unit 130 may composite the first image and the third image based on the large-small relationship among the color-specific brightness value (a brightness value of a certain color of the first image) and first and second threshold values associated with a certain color. The large-small relationship defines the magnitude relationship, e.g., whether the color-specific brightness value of the first image is greater than a first threshold value associated with a corresponding color, ii) whether the color-specific brightness value of the first image is greater than or equal to the first threshold value Th1 and smaller than the second threshold value Th2, or whether the color-specific brightness value of the first image is greater than or equal to a second threshold value associated with the corresponding color. In detail, the image composition unit 130 may generate the fourth image by composing a pixel value of a first green pixel of the first image and a pixel value of a second green pixel of the third image depending on the large-small relationship among a brightness value of the first green pixel of the first image, a first green threshold value, and a second green threshold value. In detail, when the brightness value of the first green pixel of the first image is smaller than the first green threshold value, the image composition unit 130 may generate the fourth image by using the pixel value of the first green pixel. When the brightness value of the first green pixel is greater than or equal to the first green threshold value and is smaller than the second green threshold value, the image composition unit 130 may generate the fourth image by adding the pixel value of the first green pixel and the pixel value of the second green pixel of the third image at a given ratio. When the brightness value of the first green pixel is greater than or equal to the second green threshold value, the image composition unit 130 may generate the fourth image by using the pixel value of the second green pixel.

The image composition unit 130 may generate the fourth image by composing a pixel value of a first red pixel of the first image and a pixel value of a second red pixel of the third image depending on the large-small relationship among the brightness value of the first red pixel of the first image, a first red threshold value, and a second red threshold value. In detail, when the brightness value of the first red pixel of the first image is smaller than the first red threshold value, the image composition unit 130 may generate the fourth image by using the pixel value of the first red pixel. When the brightness value of the first red pixel is greater than or equal to the first red threshold value and is smaller than the second red threshold value, the image composition unit 130 may generate the fourth image by adding the pixel value of the first red pixel and the pixel value of the second red pixel of the third image at a given ratio. When the brightness value of the first red pixel is greater than or equal to the second red threshold value, the image composition unit 130 may generate the fourth image by using the pixel value of the second red pixel.

The image composition unit 130 may generate the fourth image by composing a pixel value of a first blue pixel of the first image and a pixel value of a second blue pixel of the third image depending on the large-small relationship among the brightness value of the first blue pixel of the first image, a first blue threshold value, and a second blue threshold value. In detail, when the brightness value of the first blue pixel of the first image is smaller than the first blue threshold value, the image composition unit 130 may generate the fourth image by using the pixel value of the first blue pixel. When the brightness value of the first blue pixel is greater than or equal to the first blue threshold value and is smaller than the second blue threshold value, the image composition unit 130 may generate the fourth image by adding the pixel value of the first blue pixel and the pixel value of the second blue pixel of the third image at a given ratio. Also, when the brightness value of the first blue pixel is greater than or equal to the second blue threshold value, the image composition unit 130 may generate the fourth image by using the pixel value of the second blue pixel. How to compose images will be described in detail later.

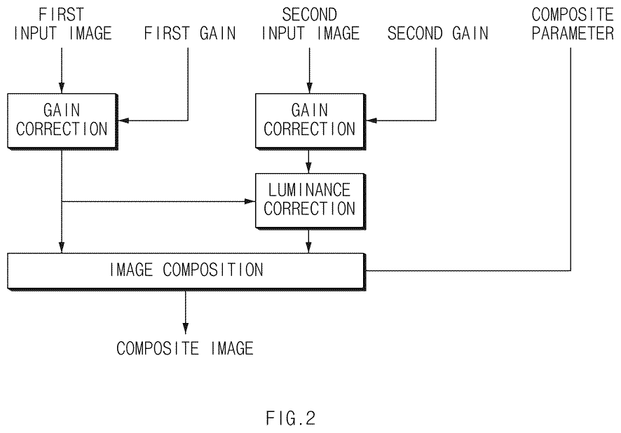

FIG. 2 is a diagram of an image processing method according to an example embodiment of the present disclosure.

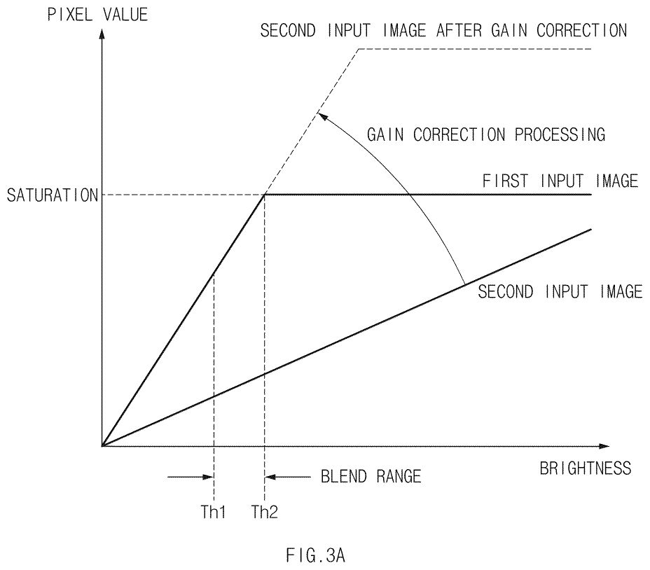

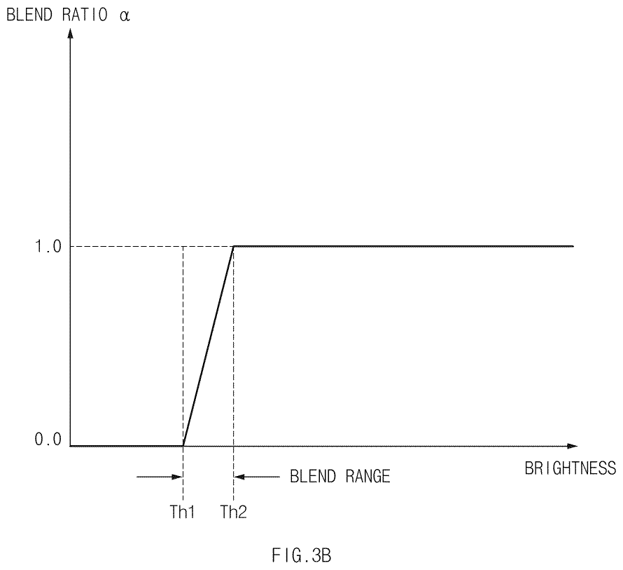

FIG. 3A is a diagram for describing an image processing method according to an embodiment of the present disclosure.

FIG. 3B is a diagram for describing an image processing method according to an example embodiment of the present disclosure.

Below, FIG. 2 will be described with reference to FIGS. 3A and 3B.

Referring to FIG. 2, an image processing method according to an example embodiment of the present disclosure may include correcting images by applying gains to the images, correcting luminance of the gains, and composing the images.

For example, a first image may be generated by applying a first gain to a first input image. Also, a second image may be generated by applying a second gain to a second input image.

Referring to FIG. 3A, the second input image may be an image which is darker than the first input image. For example, the second input image may be an image captured during an exposure time shorter than that of the first input image. Also, the first gain may be greater than the second gain. As the second gain is applied to the second input image, data for a pixel value greater than a saturation pixel value may be obtained through the second image being the second input image after gain correction.

The luminance of the second image may be corrected by using the first image. For example, the luminance of the second image may be corrected by selectively replacing the second image with the first image depending on the large-small relationship between pixel values at a same position in the first image and the second image. How to correct luminance will be described in detail later.

A composite image may be generated by composing the first image and a third image. A composite parameter may be used to generate a composite image. The composite parameter may include threshold values which are used for composition processing. In detail, the composite parameter may include a first threshold value Th1 and a second threshold value Th2 for a brightness value. For example, when brightness of a pixel of the first image, which is placed at coordinates i, j, is smaller than the first threshold value Th1, a pixel value of a pixel of the composite image, which is placed at coordinates i, j, may be a value of a pixel of the first image, which is placed at coordinates i, j. A brightness value of the pixel of the first image, which is placed at coordinates i, j, may correspond to a pixel value of the pixel of the first image, which is placed at coordinates i, j. For example, the brightness value of the pixel of the first image, which is placed at coordinates i, j, may be the pixel value of the pixel of the first image, which is placed at coordinates i, j, but the present disclosure is not limited thereto. Also, when the brightness of the pixel of the first image, which is placed at coordinates i, j, is greater than or equal to the first threshold value Th1 and is smaller than the second threshold value Th2, the pixel value of the pixel of the composite image, which is placed at coordinates i, j, may be “(1−α)*(the value of the pixel of the first image, which is placed at coordinates i, j)+α*(the value of the pixel of the third image, which is placed at coordinates i, j)”. When the brightness of the pixel of the first image, which is placed at coordinates i, j, is the second threshold value Th2, the pixel value of the pixel may be identical to a pixel value of a saturation state. However, when gain correction is made, at the brightness of the second threshold value Th2, the pixel value may be greater than or equal to the pixel value of the saturation state. Also, when the brightness of the pixel of the first image, which is placed at coordinates i, j, is greater than or equal to the second threshold value Th2, the pixel value of the pixel of the composite image, which is placed at coordinates i, j, may be a value of a pixel of the third image, which is placed at coordinates i, j. The above content will be briefly expressed by an equation as follows.

$$Composite {image}_{i , j} = \{ \begin{matrix}first {image}_{i , j} , & brightness < Th 1 \\ ( 1 - α ) \times first {image}_{i , j} + α \times third {image}_{i , j} , & Th 1 \leq brightness < Th 2 \\ third {image}_{i , j} , & Th 2 \leq brightness\end{matrix}$$

The composite image_{i,j} may mean the value of the pixel value of the composite image, which is placed at coordinates i, j. Also, the first image_{i,j} may mean the value of the pixel value of the first image, which is placed at coordinates i, j. In addition, the third image_{i,j} may mean the value of the pixel value of the third image, which is placed at coordinates i, j.

Unlike the above description, image composition may be performed based on the brightness value of the pixel of the third image, which is placed at coordinates i, j. For example, when brightness of the pixel of the third image, which is placed at coordinates i, j, is smaller than the first threshold value Th1, the pixel value of the pixel of the composite image, which is placed at coordinates i, j, may be the value of the pixel of the first image, which is placed at coordinates i, j. A brightness value of the pixel of the third image, which is placed at coordinates i, j, may correspond to the pixel value of the pixel of the third image, which is placed at coordinates i, j. For example, the brightness value of the pixel of the third image, which is placed at coordinates i, j, may be the pixel value of the pixel of the third image, which is placed at coordinates i, j, but the present disclosure is not limited thereto. Also, when the brightness of the pixel of the third image, which is placed at coordinates i, j, is greater than or equal to the first threshold value Th1 and is smaller than the second threshold value Th2, the pixel value of the pixel of the composite image, which is placed at coordinates i, j, may be “(1−α)*(the value of the pixel of the first image, which is placed at coordinates i, j)+α*(the value of the pixel of the third image, which is placed at coordinates i, j value)”. Also, when the brightness of the pixel of the third image, which is placed at coordinates i, j, is greater than or equal to the second threshold value Th2, the pixel value of the pixel of the composite image, which is placed at coordinates i, j, may be the value of the pixel of the third image, which is placed at coordinates i, j.

The image processing method according to an example embodiment of the present disclosure may set the first threshold value Th1 and the second threshold value Th2 described above for each color. Thus, assuming that there are different colored pixels in the first image or the third image, e.g., green, red, blue, the image processing method may have the first threshold values Th1 associated with the green, red, blue, respectively, and the second threshold values Th2 associated with the green, red, blue, respectively. For example, when the pixel of the first image or the third image, which is placed at coordinates i, j, is a green pixel, the first threshold value Th1 and the second threshold value Th2 may be set as a first green threshold value and a second green threshold value. Also, when the pixel of the first image or the third image, which is placed at coordinates i, j, is a red pixel, the first threshold value Th1 and the second threshold value Th2 may be set as a first red threshold value and a second red threshold value. In addition, when the pixel of the first image or the third image, which is placed at coordinates i, j, is a blue pixel, the first threshold value Th1 and the second threshold value Th2 may be set as a first blue threshold value and a second blue threshold value.

In some implementations, the first green threshold value, the first red threshold value, and the first blue threshold value may be different from each other, and at least some thereof may be identical to each other depending on a situation. Also, the second green threshold value, the second red threshold value, and the second blue threshold value may be different from each other, and at least some thereof may be identical to each other depending on a situation.

As the first image and the third image are composed at a given ratio, the composite image may be generated. For example, as described above, the pixel value of the pixel of the composite image, which is placed at coordinates i, j, may be determined as a value of ((1−α)×first image_{i,j}+α×third image_{i,j}). Referring to FIG. 3B, the value of “α” may be changed depending on the brightness value of the first image or the third image. In detail, as the brightness value of the first image or the third image increases from Th1 to Th2, the value of “α” may also linearly increase from “0” to “1”, but the present disclosure is not limited thereto.

Each of the first green threshold value and the second green threshold value, the first red threshold value and the second red threshold value, and the first blue threshold value and the second blue threshold value which are used as the first threshold value and the second threshold value may be determined by a spectral sensitivity characteristic of a color filter, a preset white balance value in a light source, a white balance value during capturing, etc. As previously described, the color filter is included in the image sensing device that provides the first input image and the second input image to the image processing apparatus 100. The white balance value may refer to the numerical parameters or setting used to perform white balance correction on the image and preset.

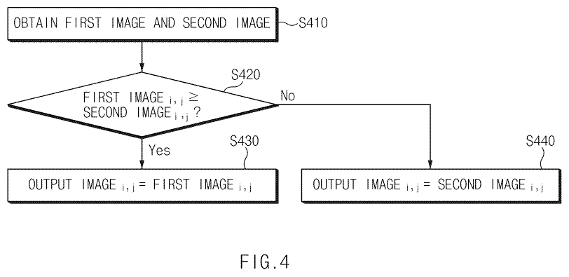

FIG. 4 is a flowchart of an image processing method according to an example embodiment of the present disclosure.

At S410, a luminance correction unit according to an example embodiment of the present disclosure may obtain a first image and a second image. The first image may be an image generated by applying a first gain to a first input image. Also, the second image may be an image generated by applying a second gain to a second input image.

At S420, the luminance correction unit may determine a first image_{i,j} being a pixel value of a pixel of the first image, which is placed at coordinates i, j, is greater than or equal to a second image_{i,j} being a pixel value of a pixel of the second image, which is placed at coordinates i, j.

When the first image_{i,j} is greater than the second image_{i,j}, at S430, the luminance correction unit may determine the first image_{i,j} as an output image_{i,j} being a pixel value of a pixel of an output image, which is placed at coordinates i, j.

Also, when the first image_{i,j} is smaller than the second image_{i,j}, at S440, the luminance correction unit may determine the second image_{i,j} as the output image_{i,j} being the pixel value of the pixel of the output image, which is placed at coordinates i, j.

In some implementations, the luminance correction unit may generate the output image by selectively replacing the second image with the first image depending on the large-small relationship between pixel values at a same position in the first image and the second image. Thus, the pixel values refer to the values from the pixels placed at the same coordinates in the first image and the second image. When a pixel value corresponding to the first image from among the pixel values of the first image and the second image, which are placed at the same coordinates, is great than the pixel value of the second image, the luminance correction unit may generate the output image by replacing the pixel value of the second image with the pixel value of the first image.

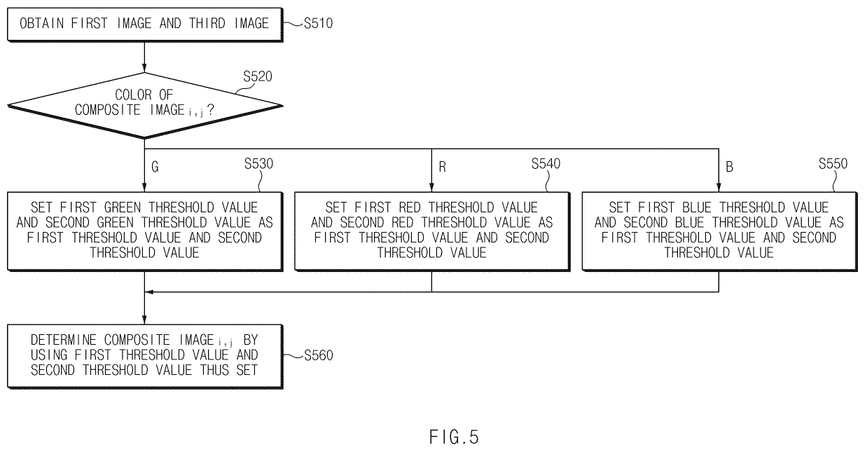

FIG. 5 is a flowchart of an image processing method according to an example embodiment of the present disclosure.

Referring to FIG. 5, at S510, an image composition unit according to an example embodiment of the present disclosure may obtain a first image and a third image from a gain control unit and a luminance correction unit.

At S520, the image composition unit may determine which color corresponds to a color of a pixel of a composite image to be generated, the pixel being placed at coordinates i, j.

When the color of the pixel of the composite image to be generated, the pixel being placed at coordinates i, j, is green, the operation proceeds at S530. At S530, the image composition unit may perform image composition by setting a first green threshold value and a second green threshold value to the first threshold value Th1 and the second threshold value Th2.

Also, when the color of the pixel of the composite image to be generated, the pixel being placed at coordinates i, j, is red, the operation proceeds at S540. At S540, the image composition unit may perform image composition by setting a first red threshold value and a second red threshold value to the first threshold value Th1 and the second threshold value Th2.

When the color of the pixel of the composite image to be generated, the pixel being placed at coordinates i, j, is blue, the operation proceeds at S550. At S550, the image composition unit may perform image composition by setting a first blue threshold value and a second blue threshold value to the first threshold value Th1 and the second threshold value Th2.

At S560, the image composition unit may determine a composite image i, j by using the first threshold value Th1 and the second threshold value Th2 that have been set. As described above, the composite image i, j may be determined by the following equation.

$$Composite {image}_{i , j} = \{ \begin{matrix}first {image}_{i , j} , & brightness < Th 1 \\ ( 1 - α ) \times first {image}_{i , j} + α \times third {image}_{i , j} , & Th 1 \leq brightness < Th 2 \\ third {image}_{i , j} , & Th 2 \leq brightness\end{matrix}$$

In some implementations, the image composition unit may compose images by differently setting brightness threshold values to be used for image composition depending on a color of a pixel of a composite image to be generated. Thus, the brightness threshold values are set to be associated with the different colors, respectively.

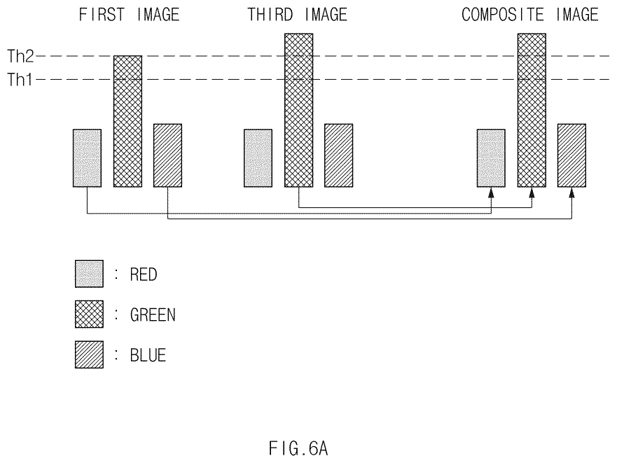

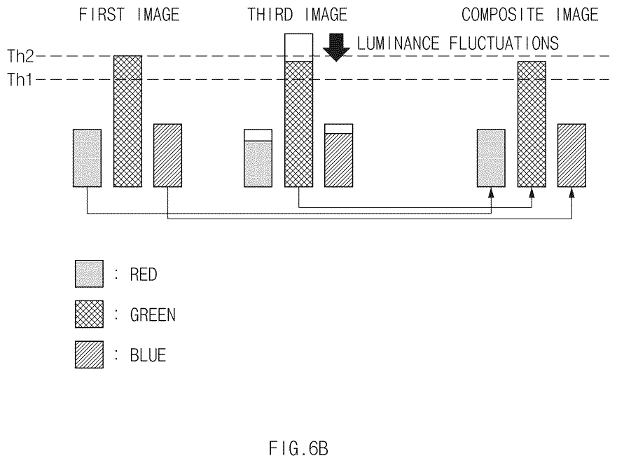

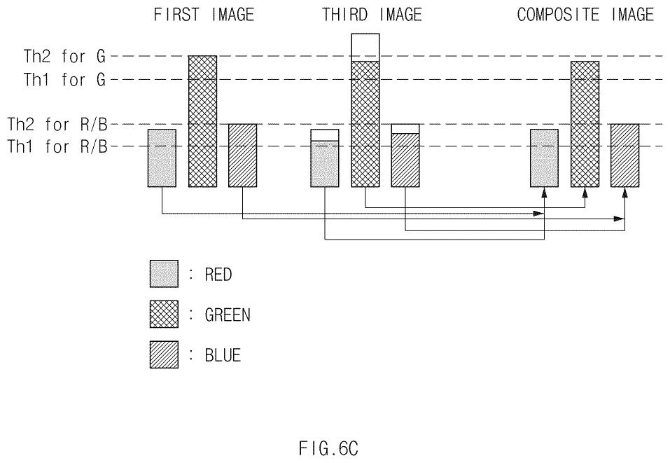

FIG. 6A is a diagram for describing an image processing method according to a comparative example.

Referring to FIG. 6A, an image processing method according to a comparative example may identically set a threshold value for a brightness value for each color, in association with image composition. In FIG. 6A, there are a single first threshold value Th1 and a single second threshold value Th2, which are applied to different colors. Thus, the threshold values (the first threshold value and the second threshold value) for a brightness value for different colors are same regardless of the color. As discussed above, the image processing method includes generating a composite image by comparing a pixel value of a first image with a first threshold value and a second threshold value, while the pixel value of the first image is a brightness value. In the example as shown in FIG. 6A, because a red pixel value and a blue pixel value of the first image are smaller than the first threshold value Th1, a red pixel value and a blue pixel value of the composite image may be determined by the red pixel value and the blue pixel value of the first image. Because a green pixel value of the first image is identical to the second threshold value, a green pixel value of the composite image may be determined as a green pixel value of a third image.

FIG. 6B is a diagram for describing an image processing method according to a comparative example. The comparative example as shown in FIG. 6B is different from the comparative example as shown in FIG. 6A due to the luminance fluctuation.

Referring to FIG. 6B, an image processing method according to a comparative example may identically set a threshold value for a brightness value for each color, in association with image composition. In FIG. 6B, there are a single first threshold value Th1 and a single second threshold value Th2, which are applied to different colors. Thus, the threshold values (the first threshold value and the second threshold value) for a brightness value for different colors are same regardless of the color. The image processing method includes generating a composite image by comparing a pixel value of a first image with a first threshold value and a second threshold value, while the pixel value of the first image is a brightness value. In the example as shown in FIG. 6B, because a red pixel value and a blue pixel value of the first image are smaller than the first threshold value Th1, a red pixel value and a blue pixel value of the composite image may be determined by the red pixel value and the blue pixel value of the first image. Because a green pixel value of the first image is identical to the second threshold value, a green pixel value of the composite image may be determined by a green pixel value of a third image. Like the third image of FIG. 6B, when a pixel value of a green pixel is smaller than a saturation value (e.g., Th2) due to the luminance fluctuation caused by a flicker phenomenon or others even after a gain is applied, however, the color of the composite image may be distorted. In detail, the red pixel value and the blue pixel value of the composite image may be determined as the red pixel value and the blue pixel value of the first image; however, as the green pixel value of the composite image is determined as the green pixel value of the third image which is smaller than a saturation pixel value as compared to an actual image, a red component and a blue component may strongly appear on the composite image.

FIG. 6C is a diagram for describing an image processing method according to an example embodiment of the present disclosure.

Referring to FIG. 6C, an image processing method according to an example embodiment of the present disclosure may differently set a threshold value for a brightness value for each color, in association with image composition. FIG. 6C shows the first threshold value Th1 for R, the first threshold value Th1 for B, the first threshold value Th1 for G, the second threshold value Th2 for R, the second threshold value Th2 for B, the second threshold value Th2 for G, which are assigned to each color, while the first threshold value Th1 for R and B is same and the second threshold value Th2 for R and B is same. The generating the composite image is performed by comparing the pixel value of the first image with the first threshold value and the second threshold value, while the pixel value of the first image is a brightness value. In the example of FIG. 6C, because the red pixel value of the first image is greater than or equal to the first red threshold value and is smaller than the second red threshold value and the blue pixel value of the first image is greater than or equal to the first blue threshold value and is smaller than the second blue threshold value, the red pixel value of the composite image may be determined by combining the red pixel value of the first image and the red pixel value of the third image, and the blue pixel value of the composite image may be determined by combining the blue pixel value of the first image and the blue pixel value of the third image. Also, because the green pixel value of the first image is identical to the second threshold value, the green pixel value of the composite image may be determined as the green pixel value of the third image. In the third image of FIG. 6C, even after a gain is applied when luminance fluctuates due to a flicker phenomenon or the like, the pixel value of the green pixel may be smaller than the saturation value; however, as the composite image is generated by combining the red/blue pixel value of the first image and the red/blue pixel value of the third image, the degree of distortion may be alleviated.

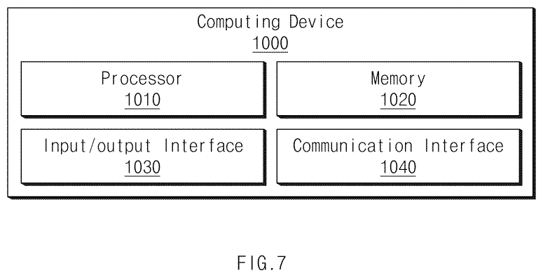

FIG. 7 is a block diagram illustrating an example of a computing device corresponding to an image processing device of FIG. 1.

Referring to FIG. 7, a computing device 1000 may show an embodiment of a hardware configuration for performing the operation of the image processing device 100 of FIG. 1.

The computing device 1000 may be mounted on a chip independent of a chip on which an image sensing device is mounted. According to an embodiment, the chip on which the image sensing device is mounted and the chip on which the computing device 1000 is mounted may be implemented with a single package, for example, a multi-chip package (MCP), but the scope of the present disclosure is not limited thereto.

The computing device 1000 may include a processor 1010, a memory 1020, an input/output interface 1030, and a communication interface 1040.

The processor 1010 may process data and/or an instruction necessary to perform the operations of the components 110, 120, and 130 of the image processing device 100 described with reference to FIG. 1.

The memory 1020 may store the data and/or the instruction necessary to perform the operations of the components 110, 120, and 130 of the image processing device 100 and may be accessed by the processor 1010. For example, the memory 1020 may be implemented with a volatile memory (e.g., a DRAM (Dynamic Random Access Memory) or an SRAM (Static Random Access Memory)) or a nonvolatile memory (e.g., a PROM (Programmable Read Only Memory), an EPROM (Erasable PROM), an EEPROM (Electrically Erasable PROM), or a flash memory).

That is, as a computer program for performing the operation of the image processing device 100 disclosed in the specification is recorded at the memory 1020 and is executed and processed by the processor 1010, the operations of the image processing device 100 may be implemented.

The input/output interface 1030 may provide an interface which connects the processor 1010 with an external input device (e.g., a keyboard, a mouse, or a touch panel) and/or an external output device (e.g., a display) such that data are transmitted/received.

The communication interface 1040 which is a component capable of exchanging various kinds of data with an external device (e.g., an application processor or an external memory) may be a device capable of supporting wired or wireless communication.

An image processing device according to an example embodiment of the present disclosure may compose images with different brightness.

The image processing device according to an example embodiment of the present disclosure may compose images by using a color-specific brightness value and different threshold values associated with each color.

The image processing device according to an example embodiment of the present disclosure may correct luminance by selectively replacing an image with another image.

When a pixel value of an image is in a saturation state, the image processing device according to an example embodiment of the present disclosure may compose images by using a pixel value of another image.

It will be appreciated by one skilled in the art that the effects that are capable of being achieved with the present disclosure are not limited to what has been particularly described hereinabove and other advantages of the present disclosure will be more clearly understood from the detailed description taken in conjunction with the accompanying drawings.

Hereinabove, although the present disclosure has been described with reference to exemplary embodiments and the accompanying drawings, the present disclosure is not limited thereto, but may be variously modified and altered by those skilled in the art to based on what is described or illustrated in this document.

What is claimed is:

1. An image processing device, comprising:
a luminance correction circuit configured to receive a first image and a second image of a target scene or object and generate a third image by selectively replacing the second image with the first image based on a relationship between pixel values at a same position in the first image and the second image; and
an image composition circuit communicatively coupled to the luminance correction circuit to receive the first image and the third image and configured to generate a fourth image by composing the first image and the third image based on a color-specific brightness value of the first image or the third image and threshold values associated with each color.

2. The image processing device of claim 1, further comprising:
a gain control circuit communicatively coupled to the luminance correction circuit and configured to:
generate the first image by correcting a first input image based on a first gain; and
generate the second image by correcting a second input image based on a second gain greater than the first gain,
wherein the first input image is captured during an exposure time longer than an exposure time of the second input image.

3. The image processing device of claim 1, wherein the image composition circuit is configured to:
generate the fourth image by using a pixel value of a first green pixel of the first image, in response to a brightness value of the first green pixel being smaller than a first green threshold value;
generate the fourth image by adding the pixel value of the first green pixel and a pixel value of a second green pixel of the third image at a given ratio, in response to the brightness value of the first green pixel is greater than or equal to the first green threshold value and is smaller than a second green threshold value; and
generate the fourth image by using the pixel value of the second green pixel, in response to the brightness value of the first green pixel being greater than or equal to the second green threshold value.

4. The image processing device of claim 1, wherein the image composition circuit is configured to:
generate the fourth image by using a pixel value of a first red pixel of the first image, in response to a brightness value of the first red pixel of the first image being smaller than a first red threshold value;
generate the fourth image by adding the pixel value of the first red pixel and a pixel value of a second red pixel of the third image at a given ratio, in response to the brightness value of the first red pixel being greater than or equal to the first red threshold value and is smaller than a second red threshold value; and
generate the fourth image by using the pixel value of the second red pixel, in response to the brightness value of the first red pixel being greater than or equal to the second red threshold value.

5. The image processing device of claim 1, wherein the image composition circuit is configured to:
generate the fourth image by using a pixel value of a first blue pixel of the first image, in response to a brightness value of the first blue pixel being smaller than a first blue threshold value;
generate the fourth image by adding the pixel value of the first blue pixel and a pixel value of a second blue pixel of the third image at a given ratio, in response to the brightness value of the first blue pixel is greater than or equal to the first blue threshold value and is smaller than a second blue threshold value; and
generate the fourth image by using the pixel value of the second blue pixel, in response to the brightness value of the first blue pixel being greater than or equal to the second blue threshold value.

6. The image processing device of claim 3, wherein the given ratio linearly changes as the brightness value of the first green pixel increases from the first green threshold value to the second green threshold value.

7. The image processing device of claim 3, wherein the first green pixel is in a saturation state in response to the brightness value of the first green pixel being identical to the second green threshold value.

8. The image processing device of claim 3, wherein the brightness value of the first green pixel corresponds to the pixel value of the first green pixel.

9. The image processing device of claim 3, wherein the first green threshold value and the second green threshold value are determined by at least some of a spectral sensitivity characteristic of a color filter of an image sensing device coupled to the image processing device and a white balance value.

10. The image processing device of claim 1, wherein the luminance correction circuit is configured to generate the third image by replacing a second pixel value of the second image with a first pixel value of the first image, in response to the first pixel value being greater than or equal to the second pixel value.

11. An image processing device, comprising:
an image composition circuit configured to receive a first image and a second image of a target scene or object, wherein the image composition circuit is configured to:
perform a first composition of a pixel value of a first green pixel of the first image and a pixel value of a second green pixel of the second image depending on a relationship between any two of a brightness value of the first green pixel of the first image, a first green threshold value, and a second green threshold value;
perform a second composition of a pixel value of a first blue pixel of the first image and a pixel value of a second blue pixel of the second image depending on a relationship between a brightness value of the first blue pixel of the first image, a first blue threshold value, and a second blue threshold value; and
perform a third composition of a pixel value of a first red pixel of the first image and a pixel value of a second red pixel of the second image depending on a relationship between a brightness value of the first red pixel of the first image, a first red threshold value, and a second red threshold value,
wherein the image composition circuit is further configured to generate a third image based on the first composition, the second composition and the third composition.

12. The image processing device of claim 11, further comprising:
a gain control circuit configured to:
generate the first image by correcting a first input image by using a first gain; and
generate a fourth image by correcting a second input image by using a second gain greater than the first gain,
wherein the first input image is captured during an exposure time longer than an exposure time of the second input image.

13. The image processing device of claim 12, further comprising:
a luminance correction circuit communicatively coupled to the image composition circuit and configured to generate the second image by selectively replacing the fourth image with the first image depending on a large-small relationship between pixel values at a same position in the first image and the fourth image.

14. The image processing device of claim 11, wherein the image composition circuit is configured to:
generate the third image by using the pixel value of the first green pixel, in response to a brightness value of the second green pixel being smaller than the first green threshold value;
generate the third image by adding the pixel value of the first green pixel and the pixel value of the second green pixel at a given ratio, in response to the brightness value of the second green pixel being greater than or equal to the first green threshold value and smaller than the second green threshold value; and
generate the third image by using the pixel value of the second green pixel, in response to the brightness value of the second green pixel being greater than or equal to the second green threshold value.

15. The image processing device of claim 11, wherein the image composition circuit is configured to:
generate the third image by using the pixel value of the first blue pixel, in response to a brightness value of the second blue pixel being smaller than the first blue threshold value;
generate the third image by adding the pixel value of the first blue pixel and the pixel value of the second blue pixel at a given ratio, in response to the brightness value of the second blue pixel being greater than or equal to the first blue threshold value and smaller than the second blue threshold value; and
generate the third image by using the pixel value of the second blue pixel, in response to the brightness value of the second blue pixel being greater than or equal to the second blue threshold value.

16. The image processing device of claim 11, wherein the image composition circuit is configured to:
generate the third image by using the pixel value of the first red pixel, in response to a brightness value of the second red pixel being smaller than the first red threshold value;
generate the third image by adding the pixel value of the first red pixel and the pixel value of the second red pixel at a given ratio, in response to the brightness value of the second red pixel being greater than or equal to the first red threshold value and smaller than the second red threshold value; and
generate the third image by using the pixel value of the second red pixel, when the brightness value of the second red pixel being greater than or equal to the second red threshold value.

17. The image processing device of claim 11, wherein the first green pixel is in a saturation state when the brightness value of the first green pixel is identical to the second green threshold value.

18. The image processing device of claim 11, wherein the first green threshold value and the second green threshold value are determined by at least some of a spectral sensitivity characteristic of a color filter and a white balance value.

19. The image processing device of claim 11, wherein the brightness value of the first green pixel corresponds to the pixel value of the first green pixel.

20. An image processing method comprising:
obtaining a first image and a second image of a target scene or object;
generating a third image by replacing a second pixel value of the second image with a first pixel value of the first image, in response to the first pixel value is greater than or equal to the second pixel value; and
generating a fourth image by composing the first image and the third image by using a color-specific brightness value of the first image or the third image and threshold values associated with each color.
